(19) United States
(12) Patent Application Publication
(10) Pub. No.: US 2014/0040069 A1
(43) Pub. Date: Feb. 6, 2014

(54) METHOD AND SYSTEM FOR FACILITATING FINANCIAL TRANSACTIONS

(71) Applicants: Christian TOMASOFSKY, Stamford, CT (US); Zavida Mangaru, Valley Stream, NY (US); David Lim, New York, NY (US); Greg Williamson, Mount Kisco, NY (US)

(72) Inventors: Christian TOMASOFSKY, Stamford, CT (US); Zavida Mangaru, Valley Stream, NY (US); David Lim, New York, NY (US); Greg Williamson, Mount Kisco, NY (US)

(73) Assignee: MasterCard International Incorporated, Purchase, NY (US)

(21) Appl. No.: 13/562,996

(22) Filed: Jul. 31, 2012

(51) Int. Cl. G06Q 20/40; G06Q 30/06

(52) U.S. Cl. 705/26.8

(57) ABSTRACT

A method for facilitating a financial transaction includes: receiving, by a receiving device, product details associated with a product available for purchase, wherein the product details includes at least a product identifier, a purchase amount, and a merchant identifier; storing, in a database, the received product details; identifying a uniform resource locator (URL) corresponding to a webpage; and transmitting, by a transmitting device, the URL to a third party, wherein the product is available for purchase on the webpage and the webpage is configured to transmit, to the receiving device, an authorization request for a financial transaction, the financial transaction including at least the product available for purchase.

### FIELD

The present disclosure relates to facilitating financial transactions on a merchant webpage, specifically receiving product details to generate a window for inclusion on a merchant webpage that can separately process a financial transaction on behalf of the merchant.

### BACKGROUND

In the last two decades, Internet-based commerce has grown considerably. In present times, many consumers do the majority of their shopping online. At the same time, however, the number of stolen identities is increasing, due in part to consumers engaging in online commerce. As a result, many merchants and manufacturers may use a variety of security measures when processing transactions through their respective websites.

The implementation of such significant security measures, in addition to providing the capability of purchasing products and processing transactions, can involve significant time, expense, and expertise for merchants and manufacturers. Some merchants and manufacturers, especially small businesses and new business operations, may lack the resources necessary to be able to provide a safe and secure Internet commerce environment. As a result, these businesses may lose out on a significant amount of profits by not providing an Internet-based store.

Thus, there is a perceived opportunity to improve the processing of financial transactions online by facilitating the processing of transactions for merchant and manufacturer websites that may not have the technology or resources available for processing financial transactions independently.

### SUMMARY

The present disclosure provides a description of a systems and methods for facilitating financial transactions.

A method for facilitating a financial transaction includes: receiving, by a receiving device, product details associated with a product available for purchase, wherein the product details includes at least a product identifier, a purchase amount, and a merchant identifier; storing, in a database, the received product details; identifying a uniform resource locator (URL) corresponding to a webpage; and transmitting, by a transmitting device, the URL to a third party, wherein the product is available for purchase on the webpage and the webpage is configured to transmit, to the receiving device, an authorization request for a financial transaction, the financial transaction including at least the product available for purchase.

A system for facilitating a financial transaction includes a receiver, a database, a processor, and a transmitter. The receiver is configured to receive product details associated with a product available for purchase, wherein the product details includes at least a product identifier, purchase amount, and a merchant identifier. The database is configured to store the received product details. The processor is configured to identify a uniform resource locator (URL) corresponding to a webpage. The transmitter is configured to transmit the URL to a third party. Additionally, the product is available for purchase on the webpage and the webpage is configured to transmit, to the receiver, an authorization request for a financial transaction, the financial transaction including at least the product available for purchase.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for facilitating a financial transaction in accordance with exemplary embodiments.

FIG. 2 is a block diagram illustrating a processing server in accordance with exemplary embodiments.

FIG. 3 is a block diagram illustrating a product detail data set in accordance with exemplary embodiments.

FIGS. 4A and 4B are a processing flow illustrating a method for facilitating and processing a financial transaction in accordance with exemplary embodiments.

FIGS. 5A-5D are diagrams illustrating a graphical user interface for a financial transaction facilitated using the method of FIGS. 4A and 4B in accordance with exemplary embodiments.

FIG. 6 is a block diagram illustrating system architecture of a computer system in accordance with exemplary embodiments.

FIG. 7 is a flow chart illustrating a method for facilitating a financial transaction in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Facilitating a Financial Transaction

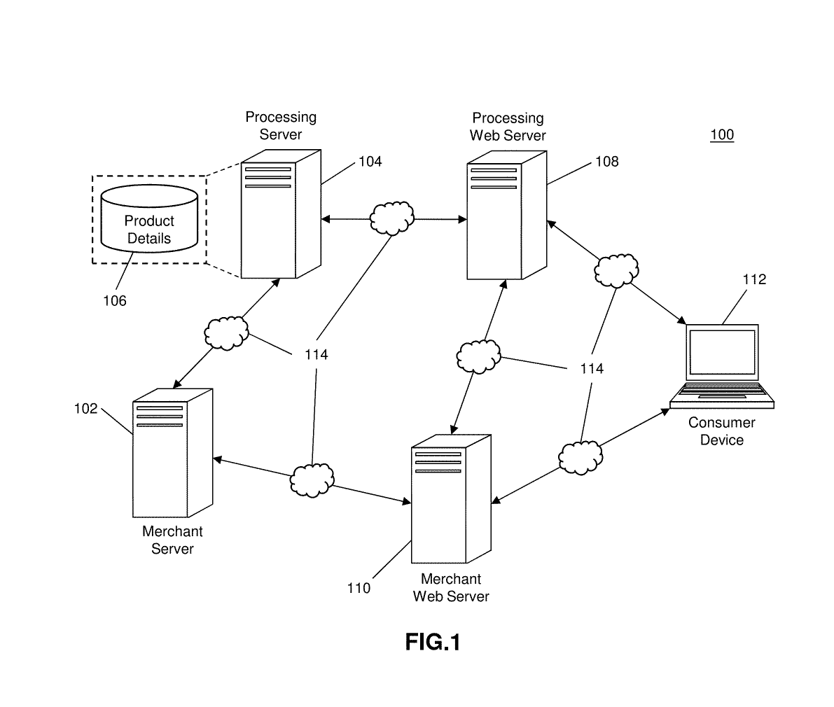

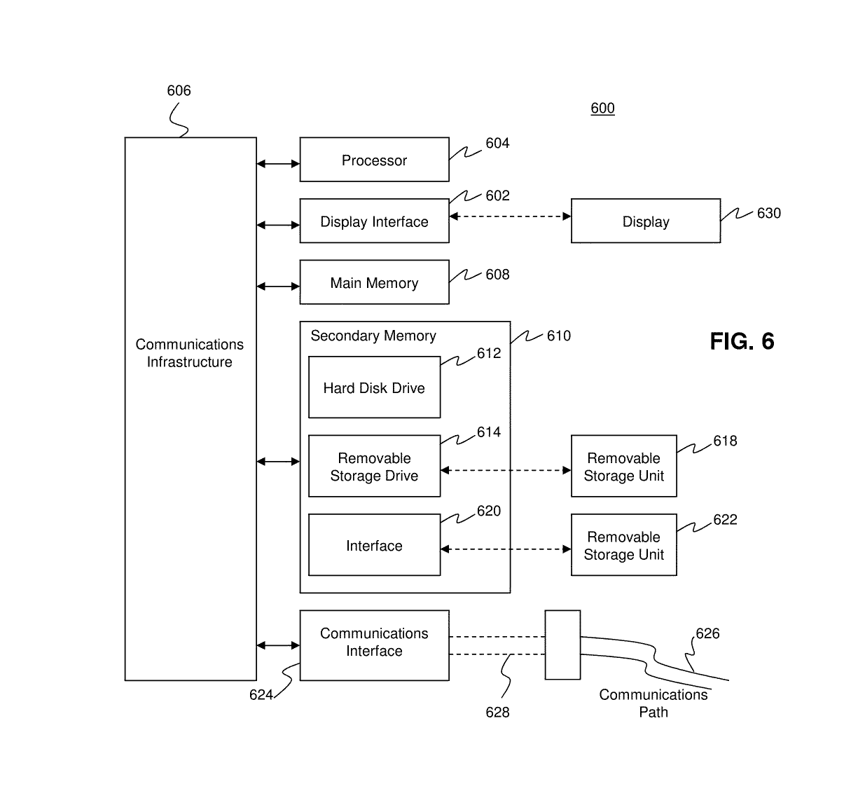

FIG. 1 illustrates a system 100 for facilitating a financial transaction. The system may include a merchant server 102, a processing server 104, a processing web server 108, and a merchant web server 110 (“servers”). Each of the servers may be a general purpose computer, which may be programmed to be a specific purpose computer, multiple computer systems interfaced together, a server, multiple servers interfaced together (e.g., a server farm), or a combination thereof. Each of the servers may be a computer system such as the computer system 600 illustrated in FIG. 6, described below.

The system 100 may also include a consumer device 112. Each of the components may communicate via a network 114. The network 114 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

The merchant server 102 may transmit product details, corresponding to a product (e.g., goods or services) available for purchase, to the processing server 104. The processing server 104 may store the received product details in a product details database 106. The product details may include any details that a consumer or merchant (e.g., of the merchant server 102) may find suitable for the initiating and conducting of a financial transaction, as discussed in more detail below.

The processing server 102 may be configured to identify a uniform resource locator (URL) corresponding to a webpage where the product corresponding to the received product details may be available for purchase (a “product webpage”). The corresponding product webpage may be hosted by the processing web server 108. In one embodiment, the processing server 102 and the processing web server 108 may be a single server. The product webpage may be configured to transmit an authorization request for a financial transaction for at least the corresponding product available for purchase (e.g., to the processing server 102).

The processing server 102 may transmit the URL to a third party, such as the merchant server 102 or the merchant web server 110. In one embodiment, transmitting the URL may include transmitting additional code to be included in a webpage. In one embodiment, the merchant web server 110 and the merchant server 102 may be a single server.

The merchant web server 110 (e.g., on behalf of the merchant server 102) may host a merchant webpage that may include the product webpage corresponding to the received URL within the merchant webpage. For example, the product webpage may be located in an inline frame on the merchant webpage, such as by using the HyperText Markup Language (HTML) <iframe> tag. In one embodiment, the merchant web server 110 may place additional code received from the processing server 104 in the merchant webpage in order to display the product webpage. In a further embodiment, the additional code may include an HTML <iframe> tag. Other methods for displaying the product webpage within the merchant webpage will be apparent to persons having skill in the relevant art. Programming languages and protocols for implementing methods of displaying the product webpage will also be apparent to persons having skill in the relevant art and may include HTML, Extensible Markup Language (XML), PHP Hypertext Preprocessor (PHP), Javascript, Asynchronous Javascript and XML (AJAX), JQuery, etc.

A consumer may navigate to the merchant webpage (e.g., hosted by the merchant web server 110) via a consumer device 112. The consumer device 112 may be any device suitable for performing the functions discussed herein as will be apparent to persons having skill in the relevant art. For example, the consumer device 112 may be a desktop computer, a laptop computer, a notebook computer, a tablet computer, a cellular phone, a smart phone, etc. The consumer device 112 may display the merchant webpage and the included product webpage (e.g., hosted by the processing web server 108). The consumer may initiate a financial transaction for the product available for purchase on the product webpage. In one embodiment, the transaction may be processed by the processing server 104.

The processing server 104, may be configured to notify the merchant server 102 of the financial transaction, as discussed in more detail below. The merchant may then finalize the transaction, such as by providing the purchased product or products to the consumer associated with the consumer device 112.

### Processing Server

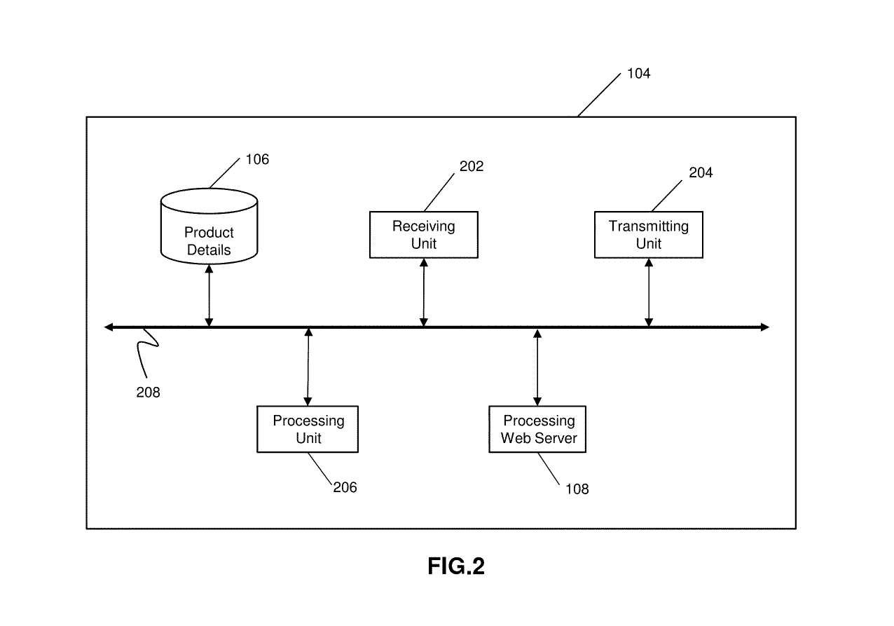

FIG. 2 illustrates an exemplary processing server 104. The processing server 104 may include the product details database 106, a receiving unit 202, a transmitting unit 204, and a processing unit 206. Each of the components may be connected via a bus 208. Suitable types and configurations of the bus 208 will be apparent to persons having skill in the relevant art. In one embodiment, the processing server 104 may also include the processing web server 108 (e.g., for hosting the product webpage).

The receiving unit 202 may be configured to receive product details corresponding to a product available for purchase. The processing unit 206 may be configured to store the received product details in the product details database 206. Product details and the product details database 206 are discussed in further detail below. The processing unit 206 may be configured to identify the URL of a webpage where the corresponding product is available for purchase. In one embodiment, the webpage may be hosted by the processing web server 108.

In some instances, a webpage may be programmed to access a database of products available for purchase, such as the product details database 106. For example, the URL may include a query string encoded with an identifier corresponding to the product available for purchase. The webpage may be programmed to retrieve from a database (e.g., the product details database 106) product details for the product corresponding to the identifier, and display the retrieved product details. Other suitable configurations for the display of product details using the webpage and URL will be apparent to persons having skill in the relevant art.

The transmitting unit 204 may be configured to transmit the identified URL (e.g., to the merchant server 102). In one embodiment, the processing server 206 may be configured to identify, and the transmitting unit 204 may be configured to transmit, programming code to the merchant server 102 for the display of the product webpage. In a further embodiment, the programming code may be configured such that the merchant web server 110 can place the programming code in the merchant webpage for display of the product webpage without a need to modify the programming code. In some embodiments, the programming code may be in a programming language specified by the merchant server 102 or the merchant web server 110 and may be modified by the processing server 102 or the merchant web server 110 for inclusion in the merchant webpage (e.g., to fit specific dimensions, aesthetics, etc.).

The receiving unit 202 may also be configured to receive notification of a financial transaction from the product webpage. In one embodiment, the receiving unit 202 may be configured to receive an authorization request for a financial transaction from the product webpage, and the processing unit 206 may be configured to process the corresponding authorization request. In an exemplary embodiment, the notification of the financial transaction may include at least product quantity and consumer information. The transmitting unit 204 may be configured to transmit the received notification of the financial transaction to the merchant server 102.

### Product Details Database

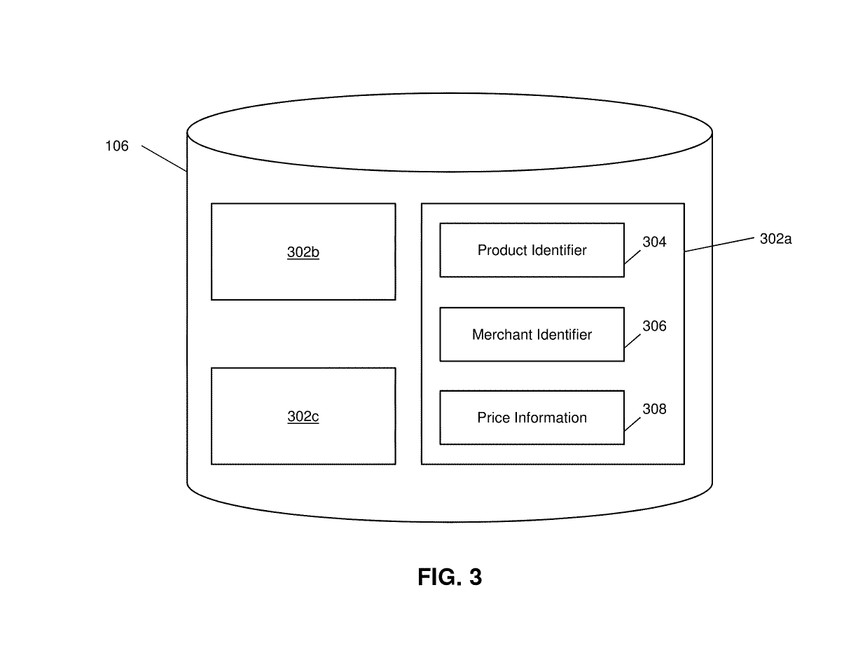

FIG. 3 illustrates the product details database 106. The product details database 106 may include a plurality of product details datasets, such as product details datasets 302a, 302b, and 302c. Each of the product details datasets 302 may include at least a product identifier 304, merchant identifier 306, and price information 308.

The product identifier 304 may be any value suitable for identifying the corresponding product. In one embodiment, the product identifier 304 may be a unique value associated with the corresponding product, such as a universal product code (UPC), stock-keeping unit (SKU), European article number (EAN), manufacturer part number (MPN), serial number, international standard book number (ISBN), etc.

The merchant identifier 306 may be a unique value associated with the merchant selling the corresponding product. The merchant identifier 306 may be included in the product details received (e.g., by the receiving unit 202) from the merchant server 102, or may be selected (e.g., identified, assigned, etc.) by the processing server 104. In one embodiment, the processing server 104 may include a merchant database configured to store merchant information, such as contact information for a merchant and the merchant's associated merchant identifier 306. Methods for identifying a merchant based on the merchant identifier 306 will be apparent to persons having skill in the relevant art.

The price information 308 may include information on the price of the corresponding product available for purchase. In one embodiment, the price information 308 may include the price at which the product is available. In another embodiment, the price information 308 may include a discount or sale price. In a further embodiment, the price information 308 may include a predetermined period of time or quantity amount at which the discount or sale price may be available.

In some embodiments, the product details dataset 302 may include additional information suitable for the sale of the corresponding product available for purchase as will be apparent to persons having skill in the relevant art. For example, the product details dataset may include the name of the corresponding product, a product description, number of products available, a maximum quantity per purchase, time period for sale of the product, available shipping options, color options, sizing options, etc.

### Transaction Window Processing Flow

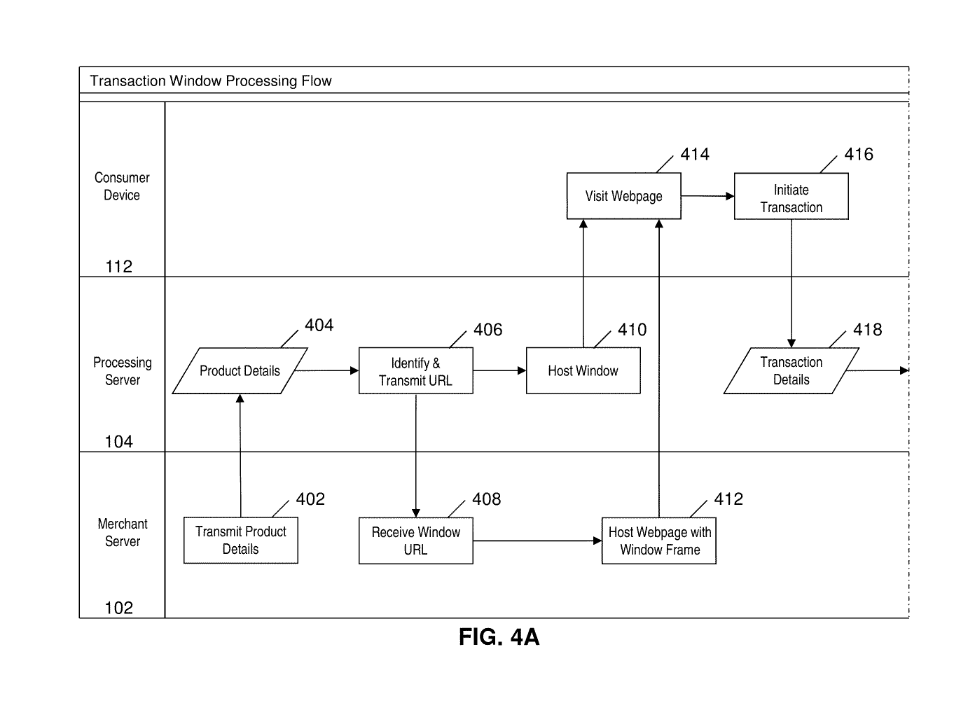

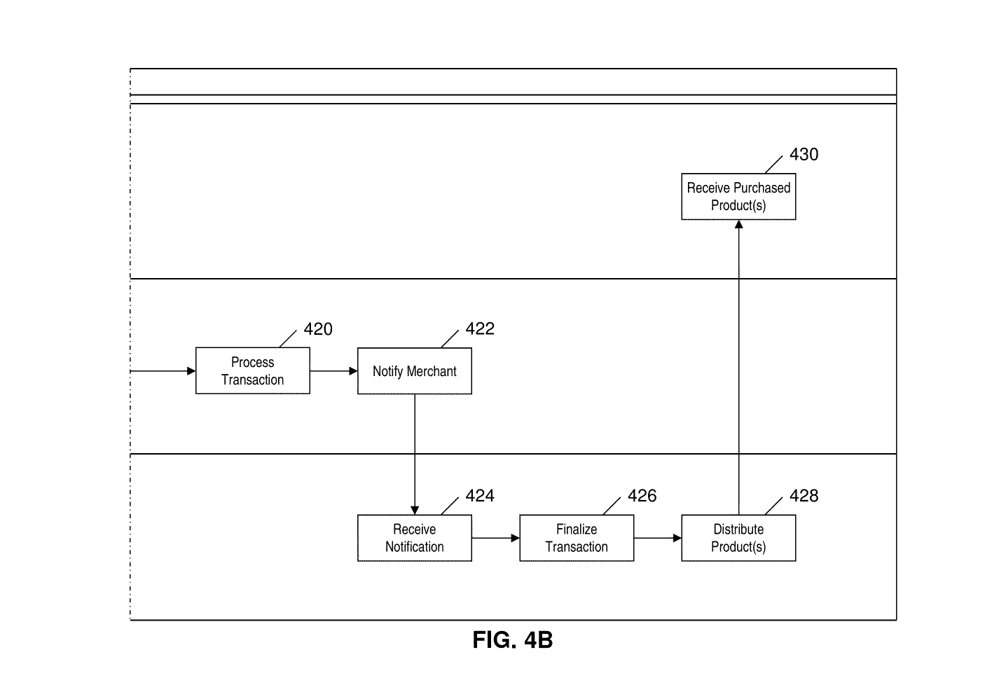

FIGS. 4A and 4B illustrate a processing flow for facilitating and processing a financial transaction using the system 100 of FIG. 1.

In step 402, the merchant server 402 may transmit product details corresponding to a product available for purchase to the processing server 104, which may store the product details (e.g., in the product details database 106) in step 404. In one embodiment, the product details may include at least a product identifier (e.g., the product identifier 304), a merchant identifier (e.g., the merchant identifier 306), and a purchase amount (e.g., included in the price information 308).

In step 406, the processing server 104 may identify a uniform resource locator (URL) corresponding to a webpage (“product webpage”) where the product available for purchase may be purchased, and transmit the URL to the merchant server 102, which may receive the URL in step 408. In one embodiment, the URL may include a query string, which may be encoded with at least a unique identifier associated with the product available for purchase. In a further embodiment, the unique identifier may be the product identifier 304.

In step 410, the processing server 104 (e.g., via the processing web server 108) may host the product webpage. In one embodiment, the product webpage may be configured to be viewed as a window (e.g., within another webpage). The product webpage may be configured such that the product available for purchase is available for purchase via the product webpage. In one embodiment, the product webpage may be configured to transmit an authorization request for a financial transaction to the processing server 102. In another embodiment, the product webpage may be configured to transmit a notification of a processed financial transaction to the processing server 102.

In step 412, the merchant server 102 (e.g., via the merchant web server 110) may be configured to host a webpage (“merchant webpage”) with the product webpage located within it. In one embodiment, the product webpage may be included in an inline frame of the merchant webpage using an HTML <iframe> tag. In some embodiments, the merchant server 102 may configure how the product webpage may be displayed within the merchant webpage. In other embodiments, the processing server 104 may provide programming code to the merchant server 102 for displaying the product webpage inside the merchant webpage. In some instances, the product webpage (e.g., or the code displaying the product webpage) may be modified for display on the merchant webpage, such as by modifying the dimensions, colors, border, etc. as will be apparent to persons having skill in the relevant art. In one embodiment, the merchant webpage may be hosted by a third party. For example, the merchant may display the product webpage within a window on a third party website, such as a social networking website.

In step 414, the consumer device 112 may visit the merchant webpage (e.g., using a web browsing application installed on the consumer device 112). Visiting the merchant webpage may display the merchant webpage including the product webpage located inside a window included in the merchant webpage. In step 416, the consumer device 112 may initiate a transaction for at least the product available for purchase via the product webpage (e.g., without navigating away from the merchant webpage). In step 418, the processing server 104 may receive transaction details for the initiated financial transaction. The transaction details may include at least the product identifier 304, a transaction amount, payment information, and consumer information. In one embodiment the consumer information may include a shipping address. In another embodiment, the consumer information may include a consumer identifier associated with a consumer.

In step 420, the processing server 104 may process the financial transaction. Methods for processing financial transactions will be apparent to persons having skill in the relevant art. In step 422, the processing server 104 may notify the merchant server 102 of the processed financial transaction. The notification may include at least the product identifier 306 and the consumer information. In one embodiment, the notification may further include a product quantity.

In step 424, the merchant server 102 may receive the notification and then, in step 426, may finalize the transaction. In embodiments where the consumer information may include a consumer identifier associated with the consumer, the merchant server 102 may identify a shipping address associated with the consumer, such as based on stored account information associated with the consumer. In step 428, the merchant server 102 may distribute the purchased product or products to the consumer associated with the consumer device 112, who may receive the product or products in step 430.

Displaying the product webpage in a window inside the merchant webpage may be beneficial for merchants that do not have the technology, resources, or security to initiate or process financial transactions themselves. The product webpage, hosted by the processing web server 108, is the only webpage that receives payment information and the only webpage that processes the transaction. Thus, the merchant server 102 and the merchant web server 110 do not need to handle sensitive information. As a result, the merchant web server 110 can engage in online commerce by providing product details to the processing server 104, displaying the product webpage from within the merchant's webpage, and then distributing the products when notified of transactions by the processing server 104. The merchant webpage can be any webpage configured to display the product webpage, such as a basic HTML webpage, without requiring security certificates and other resources.

In some embodiments, the merchant server 102 may submit additional details to the processing server 104 in step 402. For example, the merchant server 102 may submit design or aesthetic details that the processing server 104 may use when identifying (e.g., creating) the product webpage. Details that the merchant server 102 may provide the processing server 104 will be apparent to persons having skill in the relevant art, and may include color details, window shape details, window dimensions, graphical details, font details, webpage layout, button sizes, button colors, button images, etc. For example, the merchant server 102 may specify that the product webpage be formatted for a display of 250×200 pixels, have a background color of light gray, and use a black colored Arial 12-point font for text, such that the product webpage would match the merchant webpage, which may enable the product webpage to appear to be a part of the merchant webpage.

In further embodiments, the processing server 104 may provide a preview of the product webpage to the merchant server 102. In such embodiments, the merchant server 102 may be able to adjust submitted details or submit additional details to further modify the display of the product webpage. The processing server 104 may update the product webpage preview and allow the merchant server 102 to continually adjust, add, or remove details until the merchant server 102 is satisfied.

In some embodiments, the merchant server 102 may use a graphical user interface (GUI) to select details for the product webpage. For example, the merchant server 102 may be presented with multiple details to select from, while being provided with a real-time rendering of the product webpage. The merchant server 102 may select from graphically presented layouts, may select colors from a color palette for various items in the product webpage, may upload images for display on the product webpage, may select from a list of fonts and font sizes, etc. The use of a GUI for selection of details may enable the merchant server 102 to identify a product webpage suitable for display in the merchant webpage in a quicker, more user-friendly way. Types and configurations of a GUI suitable for performing the functions disclosed herein will be apparent to persons having skill in the relevant art.

### Exemplary Graphical User Interface for Facilitated Financial Transactions

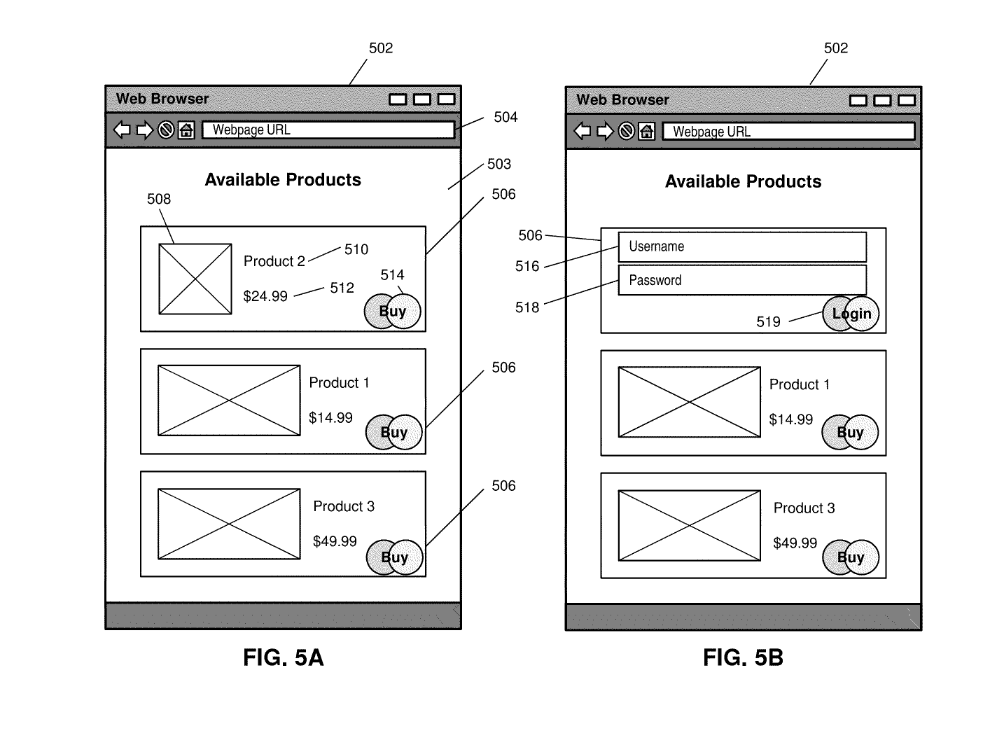

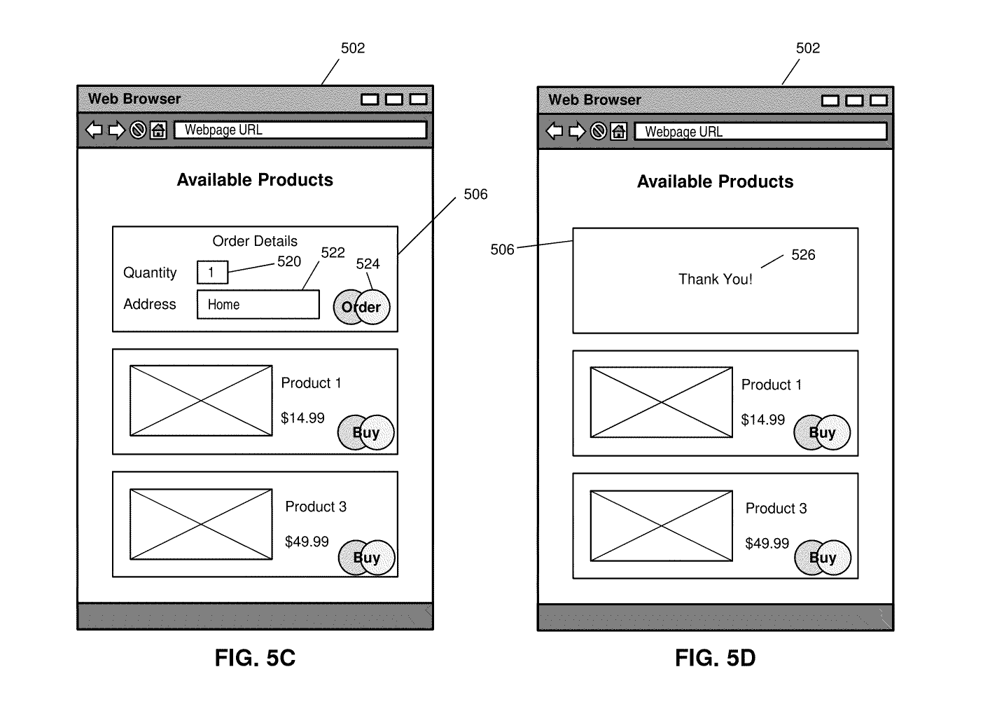

FIGS. 5A-5D illustrate exemplary user interfaces for facilitated financial transactions using the method of FIGS. 4A and 4B implemented using the system of FIG. 1.

As illustrated in FIG. 5A, a consumer may use the consumer device 112 to navigate to a merchant webpage 503, such as by using a web browser application 502 included in the consumer device 112. The merchant webpage 503 may be accessed via a webpage URL 504. The merchant webpage 503 may include a plurality of product webpages 506. Each product webpage 506 may include at least one product available for purchase and may be displayed using an inline frame in the merchant webpage 503. Other suitable methods for displaying the product webpage 506 in the merchant webpage 503 will be apparent to persons having skill in the relevant art.

The product webpage 506 may display a product image 508, product name 510, and purchase amount 512 for the corresponding at least one product available for purchase. In one embodiment, the purchase amount 512 may include a normal purchase amount and a sale purchase amount. In a further embodiment, the product webpage 506 may display an expiration time for the sale purchase amount. The product webpage 506 may also include a buy button 514. A user may interact with the buy button 514 to initiate a financial transaction for the corresponding product.

Upon interacting with the buy button 514, the product webpage 506 may request authentication of the user, as illustrated in the product webpage 506 in FIG. 5B. To authenticate the user, the product webpage 506 may include a username field 516 and a password field 518 for entering a username and password. In some embodiments, payment information may be entered (e.g., instead of authenticating an account associated with the user). Other suitable methods and interfaces for authenticating the user and/or payment details will be apparent to persons having skill in the relevant art. In one embodiment, the product webpage 506 may use cookies stored on the consumer device 112 to authenticate the user. Once the user has provided authenticating information, the user may interact with a login button 519 to submit the information to the processing web server 110.

Once the processing web server 110 has authenticated the user, the user may enter order details in the product webpage 506 as illustrated in FIG. 5C. The order details may include a quantity 520 and a shipping address 522. In one embodiment, the shipping address 522 may be selected from a list of preset shipping addresses (e.g., stored in an account associated with the authenticated user). In another embodiment, the user may enter the shipping address in the shipping address field 522. Other order detail information that may be entered in the product webpage 506 will be apparent to persons having skill in the relevant art and may include sizing information, color information, additional instructions, etc. When the user is satisfied with the entered order details, the user may interact with an order button 524 to place the order (e.g., submit the financial transaction for processing, such as to the processing server 104). After the user has placed the order, the product webpage 506 may display a confirmation message 526 notifying the user of the results of the processing of the financial transaction. The processing server 104 may notify the merchant server 102 of the completed financial transaction, and the merchant may distribute the ordered quantity 520 of products to the shipping address 522 as indicated.

As illustrated in FIGS. 5A-5D, the user may initiate and conduct the financial transaction using the product webpage 506, without navigating the web browser 502 away from the merchant webpage 503. Because the user conducts the financial transaction using the product webpage 506, the merchant webpage 503 may not need to be configured to initiate or process financial transactions.

### Server Architecture

FIG. 6 illustrates a computer system 600 in which embodiments of the present disclosure, or portions thereof, may be implemented as computer-readable code. For example, the processing server 104, processing web server 108, merchant server 102, merchant web server 110, and consumer device 112 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4A, 4B, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communication infrastructure 606, such as a bus, message queue, network (e.g., the network 122), multi-core message-passing scheme, etc. The computer system 800 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive, the removable storage unit 618 may be a floppy disk. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

Computer program medium and computer usable medium may refer to memories, such as the main memory 608 and secondary memory 610, which may be memory semiconductors (e.g. DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 4A, 4B, and 6, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

### Exemplary Method for Facilitating a Financial Transaction

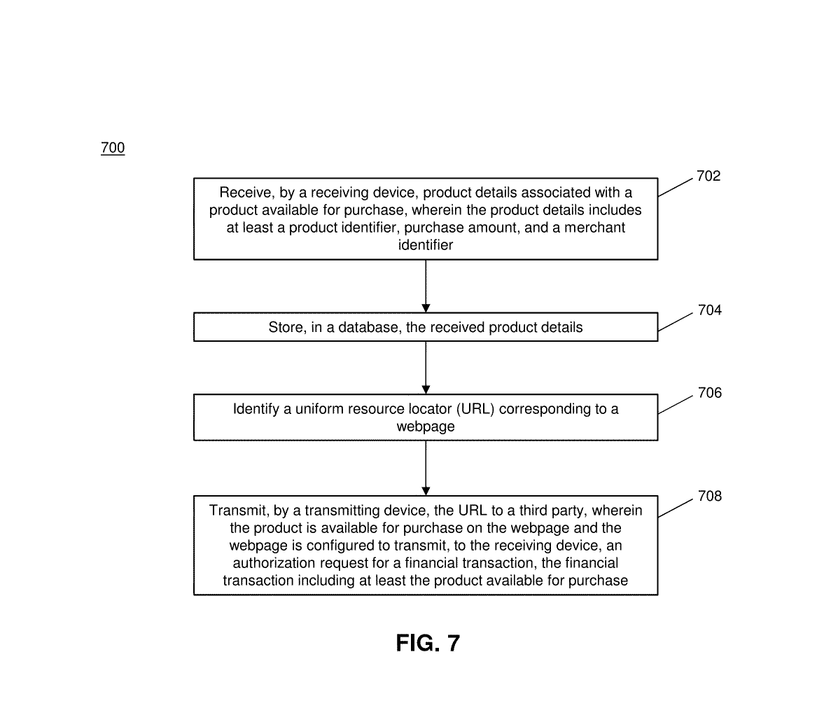

FIG. 7 illustrates a method 700 for facilitating a financial transaction.

In step 702, product details associated with a product available for purchase may be received (e.g., by the receiving unit 202), wherein the product details include at least a product identifier (e.g., the product identifier 304), a purchase amount (e.g., the price information 308), and a merchant identifier (e.g., the merchant identifier 306). In one embodiment, the product details may further include at least one of: product name, product description, sale price, quantity, expiration time, shipping options, size options, and color options. In one embodiment, the product identifier may be at least one of: a universal product code, a stock-keeping unit, European article number, manufacturer part number, serial number, and international standard book number.

In step 704, the received product details may be stored in a database (e.g., the product details database 106). In step 706, a uniform resource locator (URL) corresponding to a webpage may be identified. In one embodiment, the URL may include a query string, wherein the query string is encoded with at least one of: the product identifier 304 and a unique identifier associated with the product available for purchase.

In step 708, the URL may be transmitted by a transmitting device (e.g., the transmitting unit 204) to a third party, wherein the product is available for purchase on the webpage and the webpage is configured to transmit, to the receiving device (e.g., the receiving unit 202), an authorization request for a financial transaction including at least the product available for purchase. In one embodiment, transmitting the URL may include transmitting webpage code configured to display the corresponding webpage. In some embodiments, the third party may be a merchant associated with the merchant identifier 306. In one embodiment, the authorization request may be formatted in the International Organization for Standardization ISO 8583 standard.

In some embodiments, the method 700 may further include hosting, by a web server (e.g., the processing web server 108), the webpage. In some embodiments, the method 700 may include: receiving, by the receiving device (e.g., the receiving unit 202), the authorization request for the financial transaction transmitted by the webpage, wherein the authorization request includes at least consumer information; processing, by a processor (e.g., the processing unit 206), the received authorization request; and transmitting, by the transmitting device (e.g., the transmitting unit 204), transaction information, wherein the transaction information includes at least the product identifier 304 and the consumer information. In one embodiment, the consumer information may include at least a shipping address. In another embodiment, the consumer information may include a consumer identifier associated with a consumer. In one embodiment, transmitting the transaction information may include transmitting the transaction information to the third party.

Techniques consistent with the present disclosure provide, among other features, systems and methods for distributing content to devices, initiating financial transactions, processing electronic financial transactions using a payer device and pay codes, and indirectly controlling websites. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method of facilitating a financial transaction, comprising:
receiving, by a receiving device, product details associated with a product available for purchase, wherein the product details includes at least a product identifier, a purchase amount, and a merchant identifier;
storing, in a database, the received product details;
identifying a uniform resource locator (URL) corresponding to a webpage; and
transmitting, by a transmitting device, the URL to a third party,
wherein the product is available for purchase on the webpage and the webpage is configured to transmit, to the receiving device, an authorization request for a financial transaction, the financial transaction including at least the product available for purchase.

2. The method of claim 1, further comprising:
receiving, by the receiving device, the authorization request for the financial transaction transmitted by the webpage, wherein the authorization request includes at least consumer information;
processing, by a processor, the received authorization request; and
transmitting, by the transmitting device, transaction information, wherein the transaction information includes at least the product identifier and the consumer information.

3. The method of claim 1, wherein the URL includes a query string, and wherein the query string is encoded with at least one of: the product identifier and a unique identifier associated with the product available for purchase.

4. The method of claim 1, wherein transmitting the URL corresponding to a webpage includes transmitting webpage code configured to display the corresponding webpage.

5. The method of claim 1, wherein the third party is a merchant associated with the merchant identifier.

6. The method of claim 1, wherein the product identifier is one of: a universal product code, stock-keeping unit, European article number, manufacturer part number, serial number, and international standard book number.

7. The method of claim 1, wherein the product details further includes at least one of: product name, product description, sale price, quantity, expiration time, shipping options, size options, and color options.

8. The method of claim 2, wherein the consumer information includes at least a shipping address.

9. The method of claim 2, wherein transmitting the transaction information includes transmitting the transaction information to the third party.

10. The method of claim 1, further comprising:
hosting, by a web server, the webpage.

11. The method of claim 1, wherein the authorization request is formatted in the ISO 8583 standard.

12. A system for processing a financial transaction, comprising:
a receiver configured to receive product details associated with a product available for purchase, wherein the product details includes at least a product identifier, purchase amount, and a merchant identifier;
a database configured to store the received product details;
a processor configured to identify a uniform resource locator (URL) corresponding to a webpage; and
a transmitter configured to transmit the URL to a third party,
wherein the product is available for purchase on the webpage and the webpage is configured to transmit, to the receiver, an authorization request for a financial transaction, the financial transaction including at least the product available for purchase.

13. The system of claim 12, wherein
the receiver is further configured to receive an authorization request for a financial transaction, wherein the authorization request includes at least consumer information;
the processor is further configured to process the received authorization request; and
the transmitter is further configured to transmit transaction information, the transaction information including at least the product identifier and the consumer information.

14. The system of claim 12, wherein the URL includes a query string, and wherein the query string is encoded with at least one of: the product identifier and a unique identifier associated with the product available for purchase.

15. The system of claim 12, wherein the transmitting unit is further configured to transmit webpage code configured to display the webpage corresponding to the URL.

16. The system of claim 12, wherein the third party is a merchant associated with the merchant identifier.

17. The system of claim 12, wherein the product identifier is one of: a universal product code, stock-keeping unit, European article number, manufacturer part number, serial number, and international standard book number.

18. The system of claim 12, wherein the product details further includes at least one of: product name, product description, sale price, quantity, expiration time, and shipping options.

19. The system of claim 13, wherein the consumer information includes at least a shipping address.

20. The system of claim 13, wherein transmitting the transaction information includes transmitting the transaction information to the third party.

21. The system of claim 12, further comprising a web server configured to host the webpage.

22. The system of claim 13, wherein the authorization request is formatted in the ISO 8583 standard.
